(19) United States
(12) Patent Application Publication
(10) Pub. No.: US 2002/0156682 A1
(43) Pub. Date: Oct. 24, 2002

(54) Scaleable drive-thru solution for quick service vending

(75) Inventor: Philip DiPietro, Duluth, GA (US)

Correspondence Address: Paul W. Martin, NCR Corporation, Law Department, ECD-2, 101 W. Schantz Avenue, Dayton, OH, 45479-0001, US

(73) Assignee: NCR Corporation

(21) Appl. No.: 09/838,603

(22) Filed: Apr. 19, 2001

(51) Int. Cl. G06F 17/60

(52) U.S. Cl. 705/16

(57) ABSTRACT

A system for drive-thru sales of goods includes a plurality of order stations each operative to obtain an order for goods from a customer, communicate the order to an order filler, communicate a price to the customer, and obtain payment from the customer. The system also includes a plurality of waiting stations each operative to provide a space where the customer waits for her ordered goods. The system is characterized in that the order stations are each in a different location from the waiting stations, and in that the customer is in or on a vehicle.

### FIELD OF THE INVENTION

The present invention relates generally to business automation such as an improved system and method for efficiently ordering and then receiving goods, and more particularly to a system and method for decreasing delay times and service inconsistencies pertaining to ordering, paying for and receiving goods at a drive-thru facility of a quick service vendor.

### BACKGROUND

Certain businesses have automated practices that are designed to make the business more efficient. While the general concepts of these automated business practices provide a sound basis for more efficient service, it has been recognized that current implementation of the general concepts of automation in some businesses has fallen short of achieving this goal.

One type of business application in need of improved efficiency is a drive-thru facility at a quick service vendor. Probably the best example of such a facility is a drive-thru lane at a “fast food” restaurant, although the general deficiencies discussed herein pertain to all similar drive-thru facilities. A drive-thru facility at a quick service vendor such as a fast food restaurant has traditionally been designed to operate in a serial fashion. There is typically one queue (two in some cases) for waiting in line until a menu is visible on a display board adjacent a vehicle's side, reviewing the menu to decide on an order, waiting to order after deciding which items are desired, placing the order, waiting in line to pay for the order, paying for the order, waiting for receipt of the order and, finally, receiving the product. During high-volume hours of operation, the serial method of operating the drive-thru facility causes dramatic inefficiency that affects the “total service time,” a time beginning when a vehicle enters the drive-thru line and ending when the customer receives her product and drives away. This inefficiency also affects individual component times of the total service time. Due to the serial design of the conventional quick service drive-thru service facility, a problem at any point in the queue will affect the total service times for all subsequent customers in the queue. As a result, customer satisfaction is adversely affected, thereby decreasing repeat business and revenue potential.

There are several different causes of delay and inefficiency in the conventional drive-thru facility. A customer may take an excessive amount of time to decide on her order. A fixed distance between an ordering station and a pickup/payment station necessarily determines a corresponding fixed number of orders that are actively being processed at any given time for a number of vehicles between the ordering station and the pickup window. For example, after one customer has placed her order, a next customer may be delayed in placing an order because the first customer's car has not moved forward enough for the next customer to drive to the ordering station. Since a customer waiting to arrive at an ordering station must follow the vehicles ahead of her, a fixed maximum number of vehicles along this fixed distance determines a maximum output available for the drive-thru facility for a given time.

Additionally, a fast food restaurant or other vendor's personnel may not be adequately trained, or may commit errors in processing an order. Such processing errors may include, for the restaurant example, inaccurate filling of food or beverage orders, or a failure to provide a proper selection or amount of condiments, napkins, or utensils. Also, special or customized orders placed by the customer create delays in order preparation time. After a customer has left the ordering station, the customer may decide to change her order or to add extra items to her order. Such a customer will then request the changed order or add-on at the pickup/payment window, creating additional delays.

Further problems can occur regarding a customer's payment for an order, including the customer having inadequate funds, the restaurant employee providing incorrect change, the employee having to leave the payment station in order to obtain additional money for changing a large denomination bill, and disputes over a payment calculation. As a final example, the restaurant or other vendor may be inadequately staffed or the restaurant's workflow design may require a single employee to perform too many tasks at once, such as taking the order, handling payment, delivering product, and preparing drinks.

The time delay created by these individual activities is compounded by an occurrence of concurrent multiple sources of delay, and the aggregate of the delays resulting from the serial nature of the drive-thru station can result, for example, in ‘not-so-fast food,’ where the intended purpose of the drive-thru station is wholly defeated. The cumulative nature of the delays is exemplified by the following sample drive-thru total service time data taken from a quick service restaurant: 2:59 when two cars or less are in line; 5:51 when three to five cars are in line; 7:24 when six to eight cars are in line; and 9:01 when nine or more cars are in line.

Further, the traditional serial type drive-thru is not adaptable or scaleable in terms of changing a service capacity, altering and improving a workflow to prevent “bottlenecks,” or designing a solution that meets the individual needs of a particular restaurant. The conventional drive-thru facility, therefore, is inefficient because an unalterable division of tasks may result in one employee being too busy while another is idle, a restaurant manager is not able to staff the restaurant based on gradations of service capacity, and the system does not allow for changing methods to meet individual restaurants' goals.

FIG. 1 shows a prior art arrangement of a conventional drive-thru facility. An ordering station 1 typically has a vertically oriented menu board (not shown) and a two-way audio communication system 5 that allows a customer to communicate her order to a restaurant employee, and that allows the restaurant employee to communicate the customer's order back to the customer so that the order can be verified as being correct. Typically, the communications system 5 also provides a means for the restaurant employee to communicate the total cost for the order and to inquire whether the customer would like to take advantage of special promotions or whether the customer wishes any condiments, drink holders, etc. The ordering station 1 is configured so that the height of the menu and a speaker/microphone 6 part of the communications system 5 are adapted to the height of a customer's head when the customer is driving an average sized vehicle 10.

The FIG. 1 prior art drive-thru facility also includes a payment/pickup window 2, where a customer pays for her order and then receives the order. The pickup window 2 is typically designed to have a height that allows a customer to transfer money or other payment means to a restaurant employee through a driver-side window of an automobile, and to then receive the order from the restaurant employee. This fixed height can present logistical problems for customers driving vehicles 10 other than average sized automobiles. These logistical problems can include dropped money, customers being unable to reach the employee's hands to deliver money or pickup the order, the customer being unable to conveniently pay for her order using a payment method other than money, etc. The pickup window 2 may have a cost display 4, which shows the total cost of a customer's order. Due to the serial nature of the conventional drive thru facility, the displayed cost only pertains to a customer adjacent the pickup window 2. In addition, the restaurant employee may not have updated the cost information being fed to the cost display.

The pickup window 2 typically has a moveable window (not shown) that the employee must open and close each time the employee wants to interact with the customer. Besides the opening and closing of the moveable window adding to the total service time, additional logistical problems arise due to the use of the moveable window. These additional logistical problems include the employee not being able to hear the customer if any additional problems with the payment or the order occur.

The prior art drive-thru facility of FIG. 1, as previously discussed, has a fixed distance between the ordering station 1 and the pickup/payment station 2 that limits a number of vehicles that can be serviced at a given time. The conventional facility has a single lane driving area 3 with an entrance and an exit.

With reference to FIG. 2, a conventional serial type drive thru facility's process flow is now described. At step 31, a customer driving a vehicle 10 enters the drive-thru lane 3 and then waits to proceed in line, up to a point where she can see a menu. If the drive-thru facility is busy, the customer may have to wait in the line for several minutes before seeing the menu. Meanwhile, the customer who has entered the line 3 usually has no escape, since most conventional drive-thru facilities have a curb or other enclosing means that isolates the drive-thru lane 3. A customer may enter the drive-thru lane 3 and discover that she has forgotten her money, or that she has forgotten a list of items to be ordered. In such a case, the customer in a conventional drive-thru facility will necessarily have to wait in line even though she will only drive through without ordering. In any event, the amount of time spent waiting at step 31 can be dependent upon the actions or inactions of the preceding customers.

At step 32, the customer arrives at a location where she is able to read a menu of food and drink selections, although this location may not yet be adjacent the ordering station 1. If the customer is already familiar with the menu, then she may already be ready to place an order. If the customer is not already familiar with the menu, or if the customer has not already decided which items she wishes to order, then the waiting at step 32 may be due to the customer herself. Another cause for the waiting period may be that a restaurant employee is unavailable to receive the customer's order. The two-way communications system 5 for communicating between the ordering station 1 and a restaurant employee inside the restaurant is conventionally used for ordering. The customer may wait at the ordering station 1 not knowing whether a restaurant employee is ready to accept an order. The restaurant employee may have communicated a message such as “May I take your order?”, before the customer was ready to order or before the customer was able to hear the message because her vehicle 10 window was still rolled up. Additional time may be spent in this attempt to establish two-way communications. In any event, the dependence of the actual ordering mechanism on the cooperation between the customer and the restaurant employee may result in the period of time spent waiting to order being extended.

At step 33, the customer communicates her order to the restaurant employee. In a conventional method, the employee may ask the customer whether she would like to take advantage of a special promotion. If the customer declines the promotional offer, this additional communication will add additional time to the ordering period. The customer may order an item that is unavailable because the restaurant has run out of the particular item, the item is no longer offered, etc. For whatever reason, although the restaurant is unable to supply the requested item, it has not been removed from the menu. After the items in the order have been communicated to the restaurant employee, typically the employee will communicate a total price of the order to the customer. Additional time may be spent as a result of the customer questioning the total order price and the restaurant employee having to itemize and explain the total order price. Thus, the ordering step 33 may also be a source of inefficiency that adds to the total service time.

In step 34, the order is forwarded to the kitchen for preparation of the food part of the order. In a typical system, the order taker enters the items of an order by means of a touch screen, which also displays the individual prices for each of the items as well as the total order price. The conventional touch screen system is configured to automatically cause a display in the kitchen to inform the kitchen personnel of the ordered items needing to be prepared. However, the serial flow of orders may result in additional inefficiencies because some items may require that the kitchen person wait for the item to finish cooking. Rather than being able to utilize this ‘cooking wait time’ for preparing another food order, the kitchen person may have to wait for the next order to be displayed. As a result, the time spent preparing the food may be extended due to the process flow of the conventional method and system.

In step 35, the customer waits until the customers in front of her have paid-for and received their orders. In a conventional drive-thru facility, the ordering station 1 is separated at a certain distance from a pickup window 2. The customer's order may be ready to deliver before the customer arrives at the pickup window 2, but the customer cannot receive her order because she is delayed by those waiting in line in front of her. If it is not a busy time of day, the customer may be able to drive up to the pickup window 2 immediately after placing her order. In that event, the customer's order may not yet be prepared. When she arrives at the pickup window 2, the customer may have to wait until a restaurant employee is available to receive payment for the order. The customer herself may require time to retrieve her purse or wallet, decide which bills or coins to use, or count bills or coins. Any of these scenarios can extend the individual service time, resulting in the domino effect of increasing the aggregate total service time for the customer and those behind her.

In step 36, the customer tenders her payment, receives change, and awaits receipt of her order. If the customer decides to use a charge card, debit card, cheque, or another money substitute, this may increase a time required to conclude the payment. If the customer or restaurant employee drops the money during an exchange, this can also add to the total service time. After finalizing the payment portion of the transaction, the customer may have to wait for delivery of the order. The restaurant employees may not have filled any drink items ordered, the kitchen may not have finished preparing any food items ordered, or the restaurant employee manning the pickup window 2 may require additional time to place items in a bag or drink holder, or place utensils and napkins in a bag with the food items. Any of these events, as well as others, may extend the individual and total service times.

In step 37, the restaurant employee delivers the order to the customer. Additional time may be required to provide extra condiments, napkins, utensils, straws, etc. Mishandling or dropping of the order may result in having to replace an ordered item or a complete order. The delivered order may have been erroneously filled, possibly due to a miscommunication in the actual ordering step 33, due to items from different orders being placed in the wrong bag by a restaurant employee, or an order being given to the wrong customer. Any of these events causes additional time to accrue and add to the total service time.

For the above-noted reasons and others, there is a need for reducing service times and inefficiencies at a drive-thru facility of a business such as a quick service restaurant.

### SUMMARY OF THE INVENTION

The present invention recognizes and addresses the foregoing problems and disadvantages, and others, of the prior art methods and systems for providing drive-thru services.

Accordingly, it is an object of the present invention to provide a system and method of drive-thru services that is scaleable.

It is another object of the present invention to provide a system that allows individual restaurants to meet their service goals, including service time, customer satisfaction, and order accuracy.

It is a further object of the present invention to reduce a total service time for a drive-thru facility.

Accordingly, in order to satisfy these objects and others, a system for drive-thru vending according to one form of the present invention includes a central station, a plurality of order stations each in communication with the central station, and a plurality of waiting stations each providing a space where the customer waits for the ordered goods. Each order station is operative to obtain an order for goods from a vehicle-mounted customer, communicate the order to the central station, indicate a price to the customer, and obtain payment for the ordered goods from the customer. The order stations are each in a different location from the waiting stations.

A method of operating a drive-thru vending business according to another form of the present invention includes: providing a plurality of self-assisted order stations at a corresponding plurality of first locations, with each self-assisted order station operative to allow a vehicle-mounted customer to select goods, order the selected goods, and pay for the goods at the corresponding one of the first locations; providing a plurality of waiting stations at a corresponding plurality of second locations, with each waiting station providing a parking space for the vehicle-mounted customer to wait; and, delivering the goods to the vehicle-mounted customer after the customer has arrived at one of the plurality of waiting stations.

A self-assisted kiosk for a drive-thru vending operation according to the present invention includes a processing unit and a memory. The memory includes software instructions adapted to enable the kiosk to perform the steps of obtaining an order for goods from a vehicle-mounted customer, communicating the order to a central station, indicating a price to the customer, and obtaining payment for the ordered goods from the customer. The self-assisted kiosk is disposed in a location apart from the central station.

### BRIEF DESCRIPTION OF THE DRAWING

The above-mentioned and other features and advantages of this invention, and the manner of obtaining them, will become more apparent and the present invention will be better understood by reference to the following description of an embodiment of the invention taken in conjunction with the accompanying drawing, wherein:

FIG. 1 is a highly schematic illustration of a prior art drive-thru facility;

FIG. 2 is a flowchart for a conventional method of providing drive-thru service;

FIG. 3 is a highly schematic illustration of an exemplary drive-thru facility according to an embodiment of the present invention;

FIG. 4 is a flowchart illustrating an exemplary method of providing drive-thru service according to an embodiment of the present invention;

FIG. 5 is a schematic illustration of a self-assisted kiosk according to an embodiment of the present invention;

FIG. 6 is a schematic illustration of a currency and coin acceptor and change provider according to an embodiment of the present invention;

FIG. 7 is a schematic diagram of an interfacing of a processing unit with the individual components of a self-assisted kiosk according to an embodiment of the present invention; and,

FIG. 8 is an illustration of an identifying marker for use in an embodiment of a system and method according to the present invention.

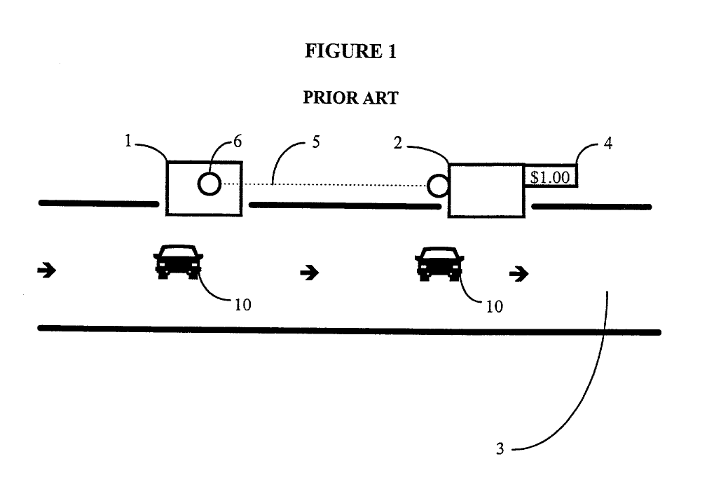

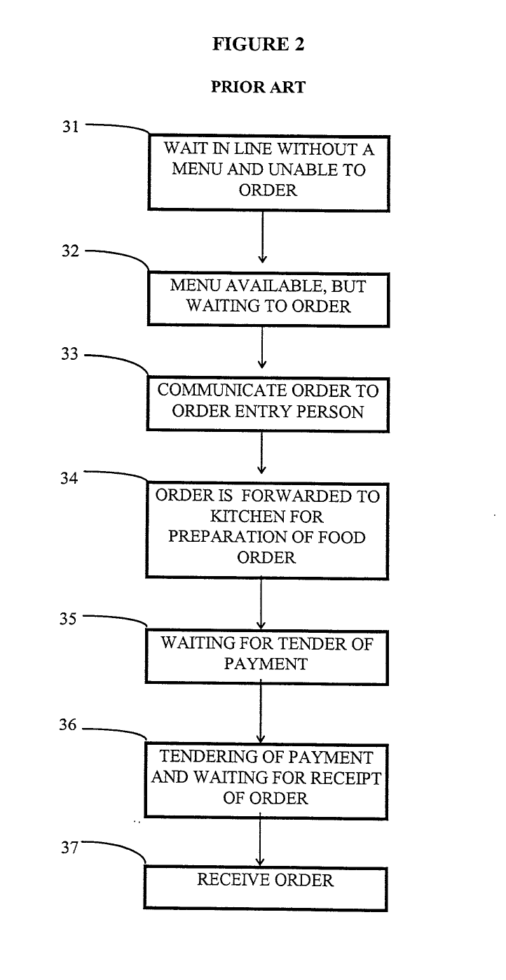

Corresponding reference characters indicate corresponding parts throughout the several views.

### DETAILED DESCRIPTION

While the invention is susceptible to various modifications and alternative forms, specific embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

As used herein, a “vehicle” can be any object used to transport a person, including an automobile, motorcycle, bicycle, bus, truck, moped, scooter, carriage, animal, boat, and others. A “customer,” as used herein, denotes a person driving a vehicle, and can also include another person or persons riding as passengers in or on the vehicle. In a situation where the driver of the vehicle is not the person who pays for or receives an order, the driver typically will conduct the transaction as an agent for the actual purchaser, although a driver may not perform certain actions such as signing a credit card.

FIG. 3 shows an exemplary system 100 for drive-thru vending according to the present invention. The quick service drive-thru vending system 100 includes a plurality of ordering stations 20, a plurality of waiting stations 40, a central station 55, at least one runner 50, and a communication system 30 for communicating orders from the ordering stations 20 to the central station 55.

A customer, driving a vehicle 10, entering the drive-thru facility 100 personally selects or is directed via a sign or the like to one of a plurality of ordering stations 20. The ordering stations 20 offer a customer the options of entering an order in a self-assisted mode, or in an assistance mode via a two-way communication system such as that described above. In a self-assisted mode, an ordering station 20 according to a preferred embodiment is operative to display an electronic menu of goods and/or services, obtain a customer's order, receive tender of payment for the order, display a receipt or total, and print a hardcopy paper receipt.

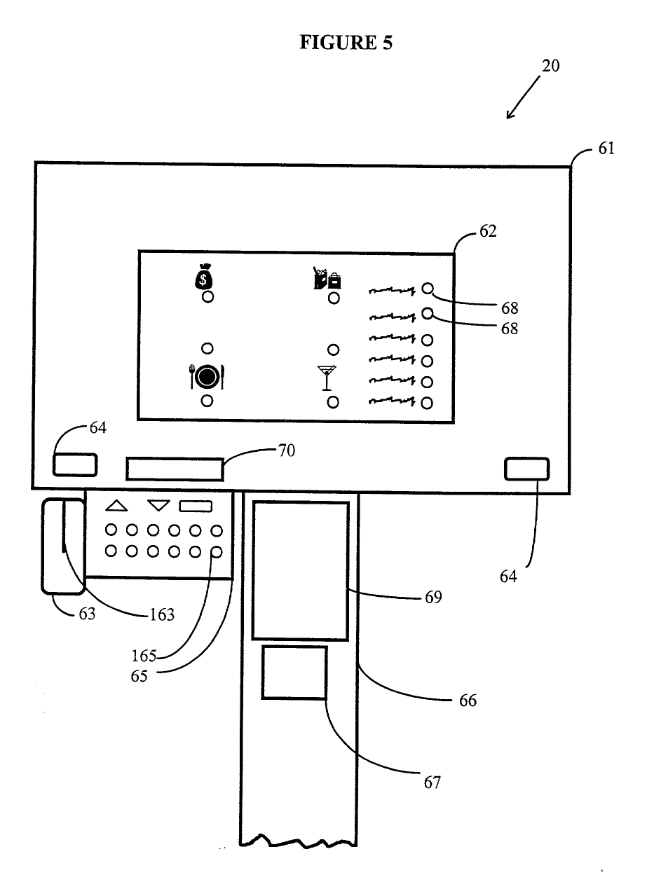

Referring to FIG. 5, a preferred embodiment of an ordering station 20 includes a kiosk 61 that utilizes a keypad and/or pushbuttons 65 for customer entry of an order. Optionally, the electronic menu display 62 is a touch screen, and the customer enters her order by pressing the symbol or picture representing the item, which then prompts the customer to subsequently press a virtual quantity or size key 68, if applicable. Optionally, the touchscreen display 62 and the keypad 65 are implemented using software that allows a customer to enter her selection by pressing either a key on the keypad 65 or a virtual button on the touchscreen display 62, whichever is most convenient. Additional forms of self-assisted order entry are envisaged, including pressing individual buttons located to each menu selection, clearing an order partially or completely, changing a menu screen, etc.

The optional touchscreen display 62 can function both as a monitor or display and as a data entry device. The touchscreen display 62 can generate data signals when certain areas of the screen are touched by the customer. In addition to, or in lieu of the display 62, a device for generating audio or voice instructions may also be included. For example, a voice generating device (not shown) may be used to inform the customer of the description and cost of each item selected for an order, thereby reducing the number of occasions in which the customer must look at the display 62 during ordering or order verification.

The ordering station 20 preferably includes speakers 64 for generating audio or voice information. The speakers 64 and a microphone 67 are used in the communication system 55, which provides two-way communication between a customer and a vendor employee located at the central station 50. Although the speakers 64 and microphone 67 are illustrated as separate components, they may be combined in a single unit, and may be positioned at any convenient position in the vicinity of the ordering station 20.

The ordering station 20 of a preferred embodiment includes a kiosk 61 that is adapted to contain most if not all of the individual components of the ordering station. Such a self-contained kiosk can be a model 7401 manufactured by NCR Corporation of Dayton, Ohio. Other types and/or models of such kiosks may be used and are contemplated. It should be appreciated at this point that any model marked herein for any purpose is only exemplary. The ordering station 20 having a kiosk 61 on a mounting base 66 is preferably configured to facilitate improved ergonomics regarding the interaction between the customer and the various mechanisms for ordering and associated functions, where the various components are mounted on telescoping or adjustable supports (not shown) so that an optimum human-engineered arrangement is implemented. User-adjustable components that can be tilted, telescoped, removed, or raised and lowered are envisaged.

The ordering stations 20 preferably are configured to operate as POS systems for receipt of tender of payment from the customer. The POS is a point-of-sale terminal that includes the display 62, keypad and/or buttons 65 for inputting a customer's selections or information, a currency and coin acceptor and change assembly 69, and a cardreader 63 for reading information encoded on a user card such as a credit card, debit card, or membership card having a magnetic strip, a barcode, or flash memory. The POS may be embodied as integrated components associated with an automated teller machine (ATM), or can be suitably configured to be integrated into a particular ordering station application. For example, a conventional ATM may offer many features and menus (e.g., funds transfer, telephone utility payment) that are inapplicable to a quick service vending establishment and, thus, a POS may be more efficiently implemented in the kiosk 61 by optimizing the functionality of the several components essential to the POS, i.e., providing for efficient customer self-payment for an order.

The magnetic strip card reader 63 is arranged to read data from a card (such as a credit card, debit card, customer identification card, SMART card, etc.) inserted in the card reader 63 via a slot 163. In a preferred embodiment, the card reader 63 operates without utilizing the keyboard 65, debiting a card's account without requiring that a PIN or other verification number be entered. Alternately, the keypad 65 is used in conjunction with the card reader 63, allowing customer entry of a PIN number. The keypad 65 has keys 165 that allow a customer to select a function and to enter numerical data. The keypad 65 optionally has its own POS display (not shown) dedicated to card transaction information.

As illustrated in FIG. 7, the kiosk 61 includes a processing unit 80 having network interface circuitry 83 that permits the kiosk 61 to communicate with an external computer in order to both output and obtain information related to payments using the magnetic strip card reader 63, and to upload or download any information relevant to the kiosk 61 operation, such as for updating menu information held in memory 84. The menu information is used to change the electronic menu and virtual buttons of the display 62 to, for example, add promotions and change prices of items. The card reader information includes authorization of a sales amount and optional verification of a customer for security reasons, e.g., confirmation of a PIN number.

The processing unit 80 is also operative to generate signals that effect a finalization of the tender of payment, thereby causing the display 62 to inform the customer that the payment for the order is complete. The payment finalization signals can also be generated by the card reader 63 or the cash input device 69. The payment finalization signals indicate that the customer's business at the ordering station 20 is over and, preferably, cause additional actions to be performed such as completing of the filling of the customer's order and informing the customer to exit the ordering station 20.

In the apparatus of the present invention, the hardware and software of a POS terminal having at least some ATM functions are integrated with the hardware and software that support additional ordering station functionality. Thus, the hardware elements of the ordering station 20 may be integrated into a single self-contained kiosk 61. Peripherals preferably connect to the processing unit 80 via a serial controller in the I/O communication device 83 in a known manner, such as by using an RS-232 or universal serial bus (USB) controller. The screen display/input unit 62 contains a known video controller that may be disposed on an adapter card or on a motherboard together with the processing unit 80.

The software architecture is designed to work with any suitable the operating system. One suitable operating system is Microsoft Windows NT.

Referring again to FIG. 6, the ordering stations 20 each preferably include a currency and coin acceptor and change assembly 69 having a bill reader 72 for inputting different denominations of currency, verifying that a bill is authentic, rejecting bills that fail a visual check, and causing the respective ordering station 20 to credit a bill's denomination to a customer's tender amount. The currency and coin acceptor and change assembly 69 also include a coin input mechanism 73, which has an input slot for accepting coins, a mechanical sifter (not shown) for identifying a coin's denomination, and an output signal device (not shown) for causing the respective ordering station 20 to credit a coin's denomination to a customer's tender amount. Each of the bill reader 72 and the coin input mechanism 73 have provisions for returning bills or coins that are rejected, and provisions for returning a change amount to the customer for money tendered in excess of the order total amount. Rejected coins or coins returned to a customer as change are output to the change receptacle 74. The currency and coin acceptor and change assembly 69 also preferably includes its own separate display 71 for indicating the amounts tendered and related currency and coin information. The display 71 provides a convenience by eliminating a need for a customer to look at a distant display when tendering cash payments.

The ordering station 20 preferably includes a printer 70 for printing a paper receipt that itemizes a customer's order, listing descriptions of the different ordered items, their prices, a sub-total, taxes, a total amount, and a method of payment that includes a card number if the customer has tendered payment using a card having a magnetic strip, such as a credit card. In addition, the ordering stations 20 are each operable to provide a customer with a displayed and/or printed order number or waiting station number. The order number or waiting station number is displayed on the ordering station's display and/or is printed on the customer's paper receipt. Alternatively, the ordering stations are operative to dispense a marker 9, as shown in FIG. 8, that a customer places on her vehicle for subsequent matching of a filled order with a particular customer's vehicle.

The ordering station 20 optionally includes a signature reader 88, which may be a model 5991 signature recognition pad marketed by NCR Corporation of Dayton, Ohio. The signature reader 88 includes a pressure transducer plate (not shown) on which a customer writes her signature using a stylus (not shown). The signature reader 88 forms an image of the signature and this image is transmitted to the processing unit 80 for storage in memory 84.

Referring back to FIG. 3, the drive-thru facility 100 also includes a plurality of waiting stations 40 which a customer enters and waits for delivery of her order. The waiting stations 40 are parking spaces for vehicles 10 and are arranged to efficiently effect a quick process flow where any individual customer is not required to wait for an available waiting station 40 after leaving an ordering station 20. The quantity of individual waiting stations should preferably be large enough to guarantee that each customer is able to immediately proceed to her waiting station 40 after leaving an ordering station 20. The waiting stations 40 may be selectably either a ‘no sustained parking’ or a ‘park-and-eat’ type. The former requires a customer to exit a waiting station after receiving her order satisfactorily and having no further requests for an adjustment in the order payment or for additional items such as condiments or napkins, etc. The latter type, for example, allows a customer to sit in her vehicle 10 at a waiting station 40 and eat her food after her order and payment have been finalized.

The waiting stations 40 each have a identification display (not shown) or identifying marker 9, which provides each waiting station 40 with a unique identification that can be seen by a customer from her vehicle 10 at or after the time when she is departing from an ordering station 20. The waiting stations 40 are optionally provided in different sizes to accommodate different sized vehicles 10. For example, in an area where a large percentage of customers are riding motorcycles, or where a quick service facility caters in large part to riders of motorcycles, it is preferable to maintain a number of the waiting stations 40 having a size and layout that more efficiently accommodates motorcycles rather than automobiles. Similarly, the waiting stations 40 may optionally be arranged so that they can have their individual size and shape be easily changed. For example, when the waiting stations include moveable partitions between adjacent ones of the waiting stations 40, their size and shape are easily changed. In such a case, the identification displays or identifying markers are moveable, so that they can accommodate the variable sizes and shapes of the waiting stations 40.

The waiting stations 40 preferably also each have call-back devices (not shown), or their equivalent, which are operable to allow a customer to request additional service after a time when all of the customer's requests had already been satisfied.

The quick service facility also includes at least one runner 50. The runner(s) 50 deliver a customer's order to the customer who is parked at a waiting station 40. A number of runners 50 is increased or decreased to accommodate different demands and service levels. The runners 50 obtain the customer's order and preferably are provided with money, condiments, utensils, and any other service items so that the runners 50 are able to satisfy most customer requirements by making only one trip to a customer's vehicle 10. Of course, should there be a problem with a food or drink order, for example, it would be necessary for the runner 50 to return to the restaurant to correct or alter the order and then return to the customer's vehicle 10. By carrying the extra service items, a runner 50 can, for example, correct or adjust the payment for an order or provide change, give a customer additional condiments or utensils, provide coupons or promotional materials to a customer, and provide a smile and good cheer that may be reciprocated by a customer who has received quick and efficient service.

The runners 50 may optionally be provided with carts (not shown) adapted, for example, to carry food and drink orders while keeping food warm and drinks cold. The runners 50 may optionally be provided with two-way communications devices (not shown) for, for example, communicating a problem with an order or customer to the restaurant from a waiting station 40. Such communication devices increase the efficiency of correcting any problems that occur when a customer is at a waiting station 40. The runners 50 may optionally be provided with wireless POS terminals (not shown) for receiving tender of payment from a customer at a waiting station 40 when a POS at an ordering station 20 is inoperable or has malfunctioned, or when an adjustment or addition to an order amount is required for the customer at a waiting station 40 who wishes to pay for her order, for example, by using a credit card. Such wireless POS terminals are known.

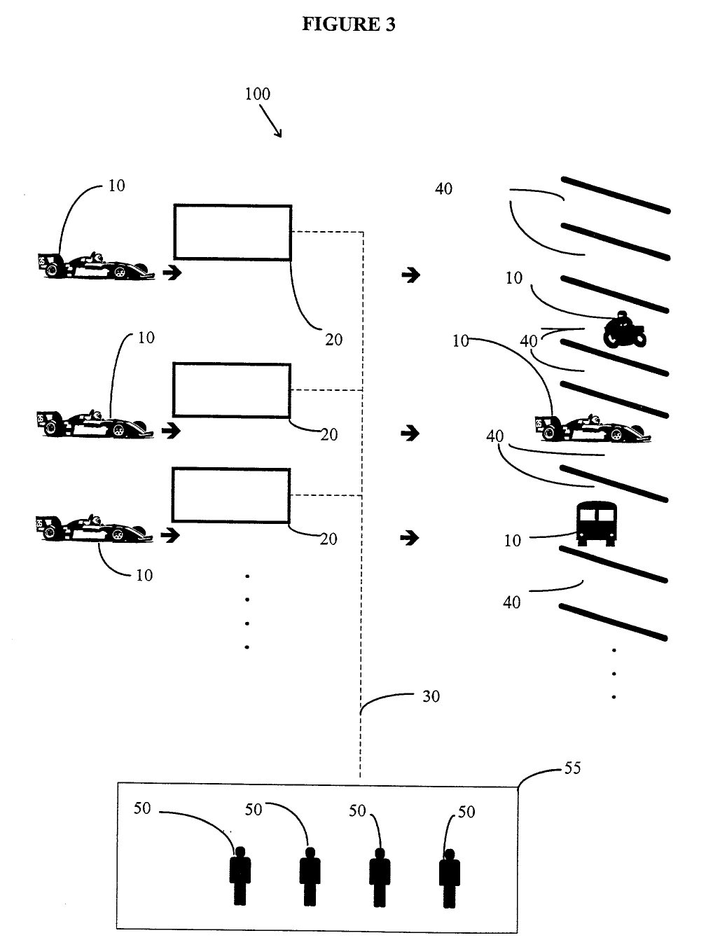

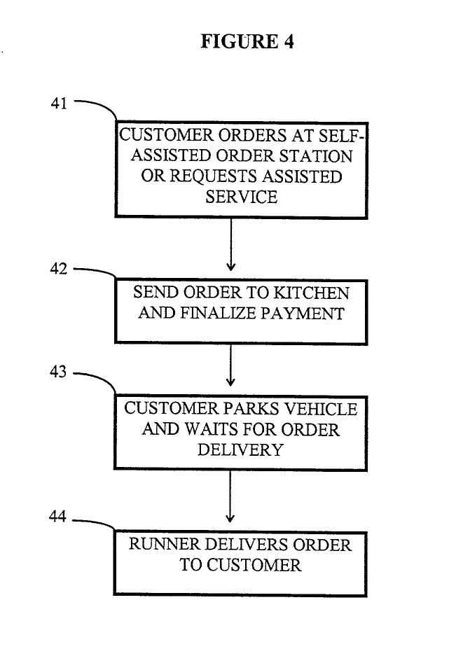

Referring to FIG. 4, an exemplary method providing a scaleable drive-thru quick service restaurant workflow according to the present invention will now be described. A customer entering the restaurant's drive-thru area must first select a lane to enter from among a plurality of service lanes. In an alternate embodiment, a lane control system may be utilized by the restaurant. In that case, a customer will obtain a lane designation by viewing a lane control display and then proceed to the lane indicated on the display. The use of the automated lane control may help prevent a bottleneck at the entrance to the drive-thru facility.

In step 41, the customer arrives at an ordering station 20. The customer then enters her order in the self-assisted mode by first viewing her menu choices, and any promotional specials, on an electronic menu 62 and then pressing a keypad 65 to identify each food item, size, and quantity desired.

In step 42, the customer verifies that the items she wishes to purchase are correctly entered by viewing an itemized list on the electronic display. In a preferred embodiment, the electronic display will prompt the customer to select a type of payment from several options that include cash, credit card, debit card, account number direct charge, and membership card. After selecting a payment method, the customer finalizes the order by pressing a button, or by any equivalent order verification action, on the ordering station 20. This order verification action of the customer causes the order to be sent to the kitchen for preparation of the ordered items and associated processing of the order. The customer can receive a paper receipt for her purchase by either pressing a receipt button located on the ordering station 20, or by answering a prompt shown on the electronic display. In a preferred embodiment, the paper receipt lists a specific numbered waiting station 40 or the electronic display shows the specific numbered waiting station 40 identification to the customer. In an alternate embodiment, the customer is provided with an order number that identifies her order. The order number may be provided by being printed on the paper receipt, or may be displayed on the electronic display.

In step 43, the customer drives her vehicle 10 from the ordering station 20 to one of the plurality of waiting stations 40. If the customer has been provided with an order number, she drives her vehicle 10 to a waiting station 40 having a waiting station display that shows the order number. In a preferred embodiment, the customer drives her vehicle 10 to the waiting station 40 having the specific waiting station number. Other methods of coordinating a customer with a particular waiting station 40 are envisaged, including providing a customer with an identifying marker 9, which the customer places on her vehicle 10, and including requiring a customer to flash her headlights when she sees her order number being displayed on a central display. When the customer determines which waiting station 40 to enter, she parks her vehicle 10 at the waiting station 40 and waits for delivery of her order.

In step 44, a runner 50 delivers the order to the customer. When necessary for delivery of a large order, two or more runners 50 may be required or a single runner 50 may need to make more than one trip in order to deliver the order. The runner 50 first determines the particular waiting station 40 that corresponds to an order he is delivering. This is accomplished for the above-noted variations, respectively, by viewing the order numbers being displayed on the plurality of waiting station displays, viewing numbers assigned to specific waiting stations, spotting an identifying marker 9 on a customer vehicle 10, or spotting a customer flashing her headlights. The runner 50 then proceeds to the vehicle 10 at the particular waiting station 40 and delivers the order by handing it to the customer. The runner 50 may wait until the customer has inspected her order. If the inspection shows that any items have been filled incorrectly, extra condiments, napkins or utensils are needed, or an adjustment in the customer's payment is required or change is due, the runner 50 then proceeds to satisfy the customer's requests, needs, and requirements.

The above-described system and method of the present invention enables scaleable facilities and personnel to be implemented by a quick service business. Individual times for the separate actions required for a customer's service needs, as well as the total service time, are reduced compared with conventional drive-thru systems and methods. Efficiency, customer satisfaction, order accuracy, and profits are increased by use of the present invention.

The foregoing disclosure is given for the purposes of explanation and illustration of the preferred embodiments of the present invention. Modifications, changes, additions, and deletions may be made without departing from the scope or spirit of the invention. Accordingly, the above-described embodiments are intended to be exemplary in nature, whereby the present invention is intended to be limited only by the following claims.

What is claimed is:

1. A system for drive-thru sales, comprising:
a central station;
a plurality of order stations each in communication with the central station, each order station operative to indicate a price of goods to the customer, obtain an order for goods from a vehicle-mounted customer, communicate the order to the central station, and obtain payment for the ordered goods from the customer; and
a plurality of waiting stations each providing a space where the customer waits for the ordered goods,
wherein the order stations are each in a different location from the waiting stations.

2. The system of claim 1, further comprising a display device that informs the customer which one of the plurality of order stations the customer should use.

3. The system of claim 1, wherein the plurality of order stations are each operative to be in a customer-selectable mode that is one of self-assisted and assisted.

4. The system of claim 1, wherein the plurality of order stations each comprise an electronic menu that displays to the customer descriptions of the goods for sale, any available promotions, and corresponding prices for the goods and promotions.

5. The system of claim 4, wherein the electronic menu is operative to change the displayed descriptions of the goods according to information obtained from an external source.

6. The system of claim 1, wherein the plurality of order stations are each operative to display a customer receipt and to obtain customer verification of the order.

7. The system of claim 1, wherein the plurality of order stations are each operative to obtain the payment via a customer-selection that is one of cash, credit, debit, SMART, and membership card.

8. The system of claim 1, wherein the plurality of order stations each includes one of a keypad and an array of buttons for obtaining the customer order.

9. The system of claim 1, wherein the plurality of order stations are each operative to generate a paper receipt, the paper receipt containing at least one of a printed record of a total payment received for the ordered goods, an order number, and a waiting station number corresponding to one of the plurality of waiting stations.

10. The system of claim 1, wherein the plurality of waiting stations each comprise one of an identification display and an identification marker for uniquely identifying each of the plurality of waiting stations.

11. A method of operating a drive-thru vending business, comprising:
providing a plurality of order stations at a corresponding plurality of first locations, each order station operative to allow a vehicle-mounted customer to select goods, order the selected goods, and pay for the goods at the corresponding one of the first locations;
providing a plurality of waiting stations at a corresponding plurality of second locations, each waiting station providing a parking space for the vehicle-mounted customer to wait; and
delivering the goods to the vehicle-mounted customer after the customer has arrived at one of the plurality of waiting stations.

12. The method of claim 11, further comprising directing the vehicle-mounted customer to a particular one of the plurality of order stations.

13. The method of claim 11, further comprising providing a selection of payment options for each of the plurality of order stations, including an option of tendering payment using a POS system.

14. The method of claim 11, further comprising providing a selectable assistance mode that is one of self-assisted and assisted, for each of the plurality of order stations.

15. The method of claim 16, further comprising providing each of the plurality of order stations with an electronic menu having descriptions and prices of goods for sale and descriptions of any sales promotions for the customer ordering of the goods.

16. The method of claim 11, further comprising, when the vehicle-mounted customer is located at a particular one of the plurality of order stations, providing the vehicle-mounted customer with a paper receipt, which lists itemized ordered goods and payment received for the goods.

17. The method of claim 11, further comprising, when the vehicle-mounted customer is located at a particular one of the plurality of order stations, providing the vehicle-mounted customer with an identity of a particular second location from among the plurality of second locations, and instructing the customer to proceed to the identified particular second location.

18. A self-assisted kiosk for a drive-thru vending operation, comprising:
a processing unit; and,
a memory including software instructions adapted to enable the kiosk to perform the steps of:
obtaining an order for goods from a vehicle-mounted customer;
communicating the order to a central station;
indicating a price to the customer; and
obtaining payment for the ordered goods from the customer;
wherein the self-assisted kiosk is disposed in a location apart from the central station.

19. The kiosk of claim 18, further comprising, for obtaining the order, at least one of a touch screen, a keypad, and an array of buttons.
